(19) United States
(12) Patent Application Publication
(10) Pub. No.: US 2006/0206358 A1
(43) Pub. Date: Sep. 14, 2006

(54) Medical data reporting systems, methods and devices

(76) Inventor: Stephen J. Beaver, Columbus, OH (US)

Correspondence Address: SUTHERLAND ASBILL & BRENNAN LLP, 999 PEACHTREE STREET, N.E., ATLANTA, GA, 30309, US

(21) Appl. No.: 11/365,205

(22) Filed: Feb. 28, 2006

Related U.S. Application Data
(60) Provisional application No. 60/657,039, filed on Feb. 28, 2005.

(51) Int. Cl. G06Q 10/00; G06F 19/00

(52) U.S. Cl. 705/2; 705/3

(57) ABSTRACT

Systems, devices and methods of delivering electronic medical data to a hospital or doctor's office from a laboratory, clinic, or other remote medical campus where medical data associated with a patient is sent over a network and received at a data delivery device. The data delivery device has access to one or more report templates, where the report templates are populated with at least some of the received medical data and then may be transmitted to an external device via one of several interfaces to display the populated report template. A user interface may also be provided to allow for a user to adjust/update report templates, initiate transmissions of the medical data, manipulate the display of medical data, print the medical data, store the medical data, as well as monitor and/or troubleshoot problems with the software and hardware components associated with the delivery of the medical data.

### RELATED APPLICATION

This application claims the benefit of priority to U.S. Provisional Patent Application Ser. No. 60/657,039, entitled “Medical Data Reporting Systems and Methods”, which was filed in the United States Patent and Trademark Office on Feb. 28, 2005, and is incorporated by reference herein.

### FIELD OF THE INVENTION

This invention relates to the delivery and customization of medical data reports created by laboratories at the request of medical professionals.

### BACKGROUND OF THE INVENTION

It has been well known, and quite common in the medical field, for a laboratory to deliver medical information to a doctor's office or hospital by its own dedicated line of communication. The medical information commonly delivered in this manner includes various types of lab work that is necessary for proper diagnosis of a doctor's patients including blood work, DNA reporting, reviewing X-rays, tissue analysis as well as other analytical results which aid in the treatment of patients. However, even today, the most common form of transferring this type of sensitive data is by way of a telephone line connected to a modem which is connected to a printer where the information is transmitted from the modem to the printer and then printed for review by a physician or other medical professional. This method of “send and hope” communication has no safeguards relating to privacy, security, accuracy and accountability for the sensitive data it transmits, particularly once the information is printed at the physician's office.

More recently, with the enactment of federal laws in the United States aimed at increasing the protection of patient privacy, these dedicated transmission devices have incorporated some forms of minimal error-checking (such as checking to see that all report fields have been completed such as the date, patient identification, serial number of the report, etc.) and security features including the requirement of the entry of a password or code to begin a transmission or a print operation. In these systems, if the error-checking conducted by the system detects no errors, a message is sent back to the laboratory stating that the data was successfully delivered and the system would then disconnect the doctor's office from the laboratory. However, if the error-checking detects an error or potential error the transmission is halted and a message is returned to the laboratory where the transmission originated, informing the laboratory of the potential error and requesting resubmission once the error has been addressed. Many systems now check to determine if the printer is available before sending the report to the printer. These systems also track that the printer printed the appropriate number of pages corresponding to the laboratory report stored in the system. The results of this error-checking and print monitoring are stored into the system's memory, allowing a laboratory to check the status of the report (i.e., when it printed, if it printed successfully, etc.).

However, these systems still leave many problems with secure medical data transmission that are currently faced by doctor's offices, hospitals, and laboratories unaddressed. One problem with the present means for achieving this form of data communication is that the methods of connectivity in these systems has largely remained the same since the 1960s. While the reports might be formatted in ASCII or in FAX format, the delivery method is still by a direct dial telephone connection. Additionally, there are still significant gaps in reliability, detection, and accountability for data transmissions that result in errors, delivery to the incorrect location, or no delivery altogether. Moreover, current systems are still lacking in security features, which are especially important given the level of importance and private nature of the data that is being transmitted. Current systems also fail to provide any meaningful remote system configurability, which would allow for remote maintenance, upkeep and troubleshooting to eliminate system downtime.

Further, as communication technology continues to lower the cost and complexity required to transfer large amounts of data in user-friendly formats, laboratories have shown an interest in transmitting more than just black and white text reports faxed over a phone line. Many laboratories want to convey their information in more informative, more attractive, and in some cases, more patient friendly ways through the use of color images, graphs, charts, figures or even multimedia presentations (e.g., video images or audio presentations of data, etc.). However, using current systems an increase in the data delivered to provide such reports may significantly lengthen the transmission time, which is generally undesirable. For all the above stated reasons, current laboratory report delivery systems lack connectivity options which would easily integrate and keep pace with new communication technology and new medical data processing devices which are increasingly being used in hospitals, doctor's offices, and laboratories.

Thus, a need exists for a more secure, efficient, and reliable means for transmitting laboratory data to hospitals and doctor's offices, which addresses the shortcomings of the prior art listed above as well as the wants and needs medical professionals have in this area of lab report generation and secure data transmission.

### SUMMARY OF THE INVENTION

According to an embodiment of the invention, there is disclosed a method for delivering electronic medical data to a doctor's office. The method includes receiving medical data associated with a patient over a network and providing a plurality of report templates, where at least one report template is then populated with at least a portion of the received medical data. The method also includes providing a user interface for receiving user instructions relating to the utilization of at least a portion of the plurality of medical data; and in response to receiving a request from the user interface, transmitting at least one populated report template to one or more external display devices to display (i.e., render on a screen and/or print a paper copy) the populated report template.

According to one aspect of the invention, the method may include formatting at least a portion of the received medical data to be compatible with one or more report templates. According to another aspect of the invention, the method may include providing one or more parameters for customizing report templates, where the parameters are accessible by the user interface, and one or more parameter values are adjusted (in response to user input) to alter at least a portion of at least one report template when requested from the user interface is received. According to yet another aspect of the invention, the user interface may be accessible via a web browser. In accordance with another aspect of the invention the user interface may require a password log-in. In accordance with yet another aspect of the invention, the method may include determining if the received medical data is complete and sent to the correct recipient. According to another aspect of the invention, the method may include storing the received medical data.

According to another embodiment of the invention, there is disclosed a medical data delivery device that includes a web server in communication with a network for receiving medical data and at least one memory location containing one or more medical report templates. The medical data delivery device further includes one or more interfaces, where at least one of the interfaces is in communication with one or more external devices. The medical data delivery device also includes a processor in communication with the web server for receiving the medical data and thereafter executing computer-executable instructions for retrieving at least one medical report template from the memory location(s); populating the retrieved medical report template(s) with at least a portion of the received medical data; and transmitting the populated medical report template(s) to one or more interfaces for transmission to one or more external devices.

In accordance with one aspect of the invention, the device may also include a database containing one or more parameters for customizing report templates, and the computer-executable instructions executed by the processor may further include instructions for adjusting one or more of the parameters to alter at least a portion of at least one report template. According to another aspect of the invention, the computer-executable instructions executed by the processor may further include instructions for formatting at least a portion of the received medical data to be compatible with at least one report template. In accordance with yet another aspect of the invention, the device may include a database containing one or more parameters for customizing one or more data formats compatible with at least one report template, and the computer-executable instructions executed by the processor may further include instructions for adjusting at least one parameter to alter one or more data formats compatible with at least one report template.

According to another aspect of the invention, one or more interfaces may include a user interface accessible from a remote computing device for accepting commands to be executed by the processor. In accordance with yet another aspect of the invention, the interfaces may include at least four different interface types, which include serial ports, parallel ports, phone jacks, Ethernet jacks, 802.11x wireless networking card slots, USB ports, and/or Bluetooth antennae. According to yet another aspect of the invention, the computer-executable instructions executed by the processor further include instructions for determining if the received medical data is complete and sent to the correct recipient. In accordance with another aspect of the invention, the device may include a database, where the computer-executable instructions executed by the processor further include instructions for storing at least a portion of the received medical data in the database.

According to another embodiment of the invention, there is disclosed a system for delivering medical data to a remote location. The system includes a host computer, where the host computer contains medical data associated with a patient. The system further includes a data delivery device in communication with the host server through a network. The data delivery device of the system includes at least one memory location containing a plurality of medical report templates, a plurality of interfaces, where at least one of the interfaces is in communication with at least one external device, and a processor in communication with at least one interface for receiving the medical data. Further, the processor executes computer-executable instructions for retrieving at least one medical report template from the memory location(s), populating the retrieved medical report template(s) with at least a portion of the received medical data, and sending the populated medical report template(s) to at least one interface.

In accordance with one aspect of the invention, the data delivery device of the system may further include a web server for remote system monitoring and auditing over the network. According to another aspect of the invention, the data delivery device of the system is remotely located from the host computer. In accordance with yet another aspect of the invention, the external device(s) of the system may be a printer, personal computer (PC), and/or a mobile device. According to yet another aspect of the invention, the external device of the system is in communication with the data delivery device through a second network.

### DESCRIPTION OF THE FIGURES

Having thus described the invention in general terms, reference will now be made to the accompanying drawings, which are not necessarily drawn to scale, and wherein:

FIG. 1 is a schematic block diagram of the medical report delivery system in accordance with an exemplary embodiment of the present invention.

FIG. 2 is a frontal view of the data delivery device in accordance with an exemplary embodiment of the present invention.

FIG. 3 is a rear view of the data delivery device in accordance with an exemplary embodiment of the present invention.

FIG. 4 is an example of the web interface allowing remote access to the data delivery device in accordance with an exemplary embodiment of the present invention.

FIG. 5 is an example of a user interface, such as through a web browser, for uploading medical data and/or reports to the data delivery device in accordance with an exemplary embodiment of the present invention.

FIG. 6 is a flowchart of an exemplary process of medical data transfer using the data delivery device in accordance with an exemplary embodiment of the present invention

### DESCRIPTION OF INVENTION

The present invention is directed to a data delivery system, method and/or device used to transmit data relating to laboratory reports and other medical data over multiple types of secured communication channels between hospitals, doctor's offices and/or laboratories, including fax, telephone, modem, Ethernet, wide area network (WAN), local area network (LAN), as well as capable of using a wide variety of networking protocols such as Internet Protocol, FTP, Telnet, TCP/IP, Point-to-Point Protocol (PPP), Challenge Handshake Authentication Protocol (CHAP), or other public or private networking protocols. The data delivery system and device provides for remotely accessing a data delivery device for maintenance, upkeep, troubleshooting and system auditing. The data delivery system and device also provide for customization and/or personalization of laboratory reports through the variation of system parameters, which are divided into access security levels to provide various levels of control and functionality (e.g., for customization) corresponding to the class of user accessing the system or device such as the device manufacturer, laboratory operator, or an end user physician or other medical professional.

The present invention will be described with reference to the accompanying drawings, in which exemplary embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention is described below with reference to block diagrams of systems, methods, apparatuses and computer program products according to an embodiment of the invention. It will be understood that each block of the block diagrams, and combinations of blocks in the block diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functionality of each block of the block diagrams, or combinations of blocks in the block diagrams discussed in detail in the descriptions below.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

Accordingly, blocks of the block diagrams support combinations of means for performing the specified functions, combinations of steps for performing the specified functions and program instruction means for performing the specified functions. It will also be understood that each block of the block diagrams, and combinations of blocks in the block diagrams, can be implemented by special purpose hardware-based computer systems that perform the specified functions or steps, or combinations of special purpose hardware and computer instructions.

The inventions may be implemented through an application program running on an operating system of a computer. The inventions also may be practiced with other computer system configurations, including hand-held devices, multiprocessor systems, microprocessor based or programmable consumer electronics, mini-computers, mainframe computers, etc.

Application programs that are components of the invention may include routines, programs, components, data structures, etc. that implement certain abstract data types, perform certain tasks, actions, or tasks. In a distributed computing environment, the application program (in whole or in part) may be located in local memory, or in other storage. In addition, or in the alternative, the application program (in whole or in part) may be located in remote memory or in storage to allow for the practice of the inventions where tasks are performed by remote processing devices linked through a communications network. Exemplary embodiments of the present invention will hereinafter be described with reference to the figures, in which like numerals indicate like elements throughout the several drawings.

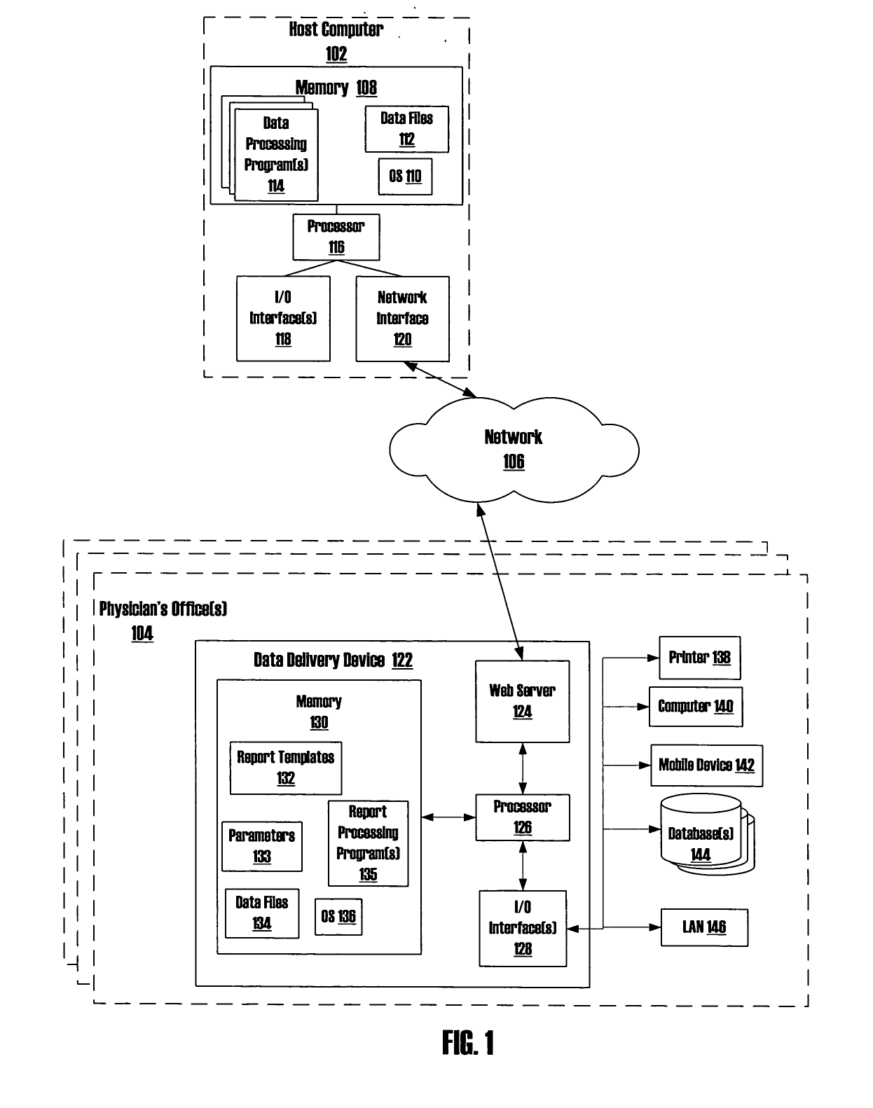

FIG. 1 is a schematic block diagram of a medical report delivery system in accordance with an exemplary embodiment of the present invention. As shown in FIG. 1, a host computer 102 is in communication with to a physician's office 104 through a network 106. The network 106 can be a dedicated private network including a LAN, WAN, T1 connection, or a public network such as the Internet. The network can also be one which supports any networking protocol including Internet Protocol, FTP, Telnet, TCP/IP, Point to Point Protocol (PPP), Challenge Handshake Authentication Protocol (CHAP), or other public or private networking protocol. In an exemplary embodiment of the present invention the network 106 is the Internet utilizing secured HTTPS protocol and user ID and password protected log-in security features. However, other secure methods of data transfer over public networks appreciable by one of ordinary skill in the art may also be used.

Typically, a laboratory is instructed by a physician's office 104 to analyze and report medical data related to patients of the physician's office 104. This analysis can include blood work, DNA reporting, reviewing X-rays, tissue analysis as well as other analytical approaches that aid in the treatment of patients. According to FIG. 1, a laboratory host computer 102, which may be located at a laboratory or other medical facility such as a clinic, hospital, etc., includes memory 108, a processor 116, I/O interfaces 118, as well as a network interface 120. In exemplary embodiments of the data delivery system, the host computer 102 takes the analyzed medical data from the laboratory and formats it for transmission over the network 106 to the physician's office 104. Once the laboratory has conducted the requested analysis resulting in medical data relating to a patient, the medical data (e.g., text, figures, charts, graphs, tables, images, audio files, video files, other forms of multimedia, etc.) to be ultimately delivered to the doctor's office is uploaded or entered into the host computer 102 through the I/O interfaces 118. This can be accomplished by manually entering the information through a keyboard, uploading the data from a disk drive, zip drive, Universal Serial Bus (USB) port, CD-ROM/DVD-ROM drive, or uploaded through direct connection or network connection to other equipment or computing devices located in or remote from the laboratory.

Once the medical data has been uploaded into the laboratory's host computer 102 memory 108, the processor 116 utilizes an operating system (OS) 110, which in turn calls data processing program 114 to collect, manipulate, and/or format the data, contained in data files 112, so the data can be properly transmitted over the network 106 to a data delivery device 122 located at a remote location such as a physician's office 104. The manipulation or formatting of the data 112 to be transmitted may be as simple as tagging elements or sections of data for insertion into a report template, which can be completed by the data delivery device 122. Alternatively, a complete laboratory report may be formatted and generated by the data processing program 114 at the host computer 102 and sent as a complete document to the data delivery device 122 located at the physician's office 104. The format of the data transmitted over the network 106 corresponds to the format or formats supported by a data delivery device 122 at the physician's office 104, which is discussed in more detail below. These formats may include text files, Microsoft Word documents, Adobe Acrobat PDF files, TIFF (fax) files, ZIP files and other data formats appreciated by one of ordinary skill in the art. Once the medical data has been manipulated by the data processing programs 114 the medical data is then sent to the network interface 120 to be sent over the network to the data delivery device 122, which may be located at a physician's office 104. Alternatively, the laboratory host computer can simply act as a transmission portal such as a server or router, and the data processing program 114 functions could be done remote from the host computer 102 all together. Once the data has been properly formatted and/or tagged, the data could then be uploaded to the host computer 102 for transmission to a remote location over the network 106.

In an exemplary embodiment of the present invention, the data delivery device 122 resides in a physician's office 104. The data delivery device 122 may include a web server 124. Alternatively, the data can be delivered to the data delivery device 122 through the I/O interfaces 128 eliminating the need for receiving the data from a web server 124. However, the use of a dedicated on board web server 124 allows the data delivery device 122 to be remotely access through the Internet or some other network such as a private Intranet, LAN, WAN, T1 connection, or other networking configurations appreciable by one of ordinary skill in the art. In an exemplary embodiment of the present invention, each data delivery device 122 has its own dedicated web server 124 providing for remote system monitoring and auditing over the network 106 (e.g., Internet). For example, an user at a laboratory may access the data delivery device 122 by accessing a secured web site through a web browser on a computer and entering a valid user identification and password, or satisfying various other methods of providing secured access. Rather than requiring a technically complex terminal emulator program to access a remote report printer as found in the prior art, any web browser (e.g., MS Internet Explorer, FireFox, Opera, Netscape, etc.) may be used to access the web server 124 of the data delivery device 122. The data delivery device 122 may provide/or be connected to a monitor for displaying a graphical interface that is continuously updated by updating files on the web server 124, as opposed to using a teletype terminal.

In an exemplary embodiment of the present invention, the data delivery device 122 includes a web server 124, a processor 126, memory 130, and I/O interfaces 128. Once the data is received by the web server 124, the processor 126 utilizes the OS 136, which in turn utilizes report processing program 135 to manipulate and/or control the delivered data, data files 134, report templates 132 and/or parameters 133 to determine if the data is valid and complete for its desired destination. The report processing program 135 also extrapolate, manipulate and/or populate report templates 132 to create custom laboratory reports using the delivered data from the remote laboratory. In an exemplary embodiment, the OS 136 operating on the data delivery device is a “standard” software system (e.g., Linux) rather than a proprietary software system.

Once the data has been determined to have been correctly sent and checked that it has been completely delivered, the transmitted data may be stored in the memory 130 of the data delivery device 122 as a data file 134, or, if the data sent is a complete laboratory report requiring no manipulation, extraction, or other processing by the report processing program 135, the data can be sent directly to the I/O interfaces 128 to be forwarded to a printer, display device, or other communication device, as will be discussed below. In an exemplary embodiment of the present invention, a complete lab report (formatted, for example, as a Word document, PDF, etc.), which is accessible through the web server 124 or I/O interfaces 128 for extraction or manipulation, is also stored in the memory 130 of the data delivery device 122 for extended accessibility and auditing purposes.

Alternatively, the data may be sent in a non-report form as a text file (and associated images, where appropriate) or formatted as any file type that the report processing program 135 can access and extract the data from to populate, for example, a pre-defined report template 132. The report templates 132 can be updated or customized through the web server 124 or I/O interface 128. To assist in the customization and manipulation of report templates or stored data, the memory 130 may include numerous user-defined parameters 133 for use by the report processing program 135, which can be accessed and modified through the web server 124 or I/O interfaces 128 and provide report customization options for the manufacturer, laboratory operator, or doctor's office operator. The parameters 133 can be used to automatically create reports that are customized specifically for a particular laboratory, doctor's office, doctor or patient every time a report is delivered.

Illustrative examples of the parameters 133 include types of data files that can populate a specific report template 132 (e.g., text file, Word document, PDF, etc.), and where in the transmitted data file to look for particular information to appropriately populate the report template 132. For example, column 1, row 1 of a text file may contain the patient's name, column two may contain doctor's office identification information, column three may contain data which corresponds to diagnosis codes or text description of symptoms, etc. The parameters 133 can be set through the web server 124 and/or I/O interface 128 to allow the report processing program 135 to determine what type of data file can populate a particular report template 132 and what portion of that data file 134 corresponds to particular data to fill in a section of a report template 132. Other forms of user defined parameters 133 as will be appreciated by one of ordinary skill in the art, include which colors or laboratory logo to establish on a report template, what types of graphics are to be used in creating the report, whether or not to include patient information sheets (which provide boilerplate descriptions that correspond to the medical data contained in the transmitted data file to provide the patient with tangible take home information about their lab test results, diagnosis, symptoms, potential remedies, etc.). Parameters 133 can also be set to perform data format conversion to and/or between Adobe Acrobat PDF files, TIFF (fax), HL7 (medical industry standard format), compressed ZIP files, etc.

It is further understood that a hierarchy of parameter 133 access can be established through various security measures including pass codes or log-in prompts including a user name, password, device serial number, etc. to provide different classes of users different levels of control over the parameters. For example, a manufacture may have the broadest access to set the parameters 133, the laboratory would the have the next broadest level of access to the parameters 133 followed by the doctor's office operator and so on. The parameters 133 can also be used not only to customize or manipulate delivered data and lab reports, but to also customize the operation of the data delivery device 122 itself, particularly the I/O interfaces 128 and their respective operation, which will be discussed in more detail below. Examples of parameters 133 than can be manipulated to change the operation of the data delivery device 122 itself include changing the methods of device connectivity the particular data delivery device 122 will accept, as well as establishing the type of secured network connections, whether it will allow remote control access and control of the device itself, or allow particular types of networking or transfer protocol, which security features to enable/disable, etc.

This customization capability of the data delivery device 122 makes it possible to offload some of the functions traditionally performed by the host computer 102 or a remote server to the remote data delivery device 122. In particular, functions such as format conversion, print image rendering and graphic rendering can be performed on the data delivery device 122 itself. Thus, host computer 102 system functions can be “projected” out to the ends of the data delivery network—i.e., the clients' data delivery devices 122—rather than being performed by the server or at the laboratory end of the network. There are a number of reasons that this “projection” of computing power may be desirable. First, the host computer 102 does not need to know or concern itself with the details of the equipment installed at the client site, rather it can confine itself to processing (or producing) lab reports in a simple, common format supported by all of the data delivery devices 122. The data delivery devices 122 will then take this “normalized” data and convert it as required by the client (e.g., physician's office) to produced the desired report. Second, because the data is transmitted in a simple, common format, it can be transmitted very quickly and inexpensively.

For example, a laboratory sending reports containing color graphics first generates the report (typically in Adobe Acrobat PDF format although other document formats can be supported such as Word, WordPerfect, or other document formats appreciable by one of ordinary skill in the art), then having determined (presumable from a database entry regarding the intended recipient) the make and model of printer that is installed at the client location, then converts the report to a printable image. This printable version of the file is typically ten to twenty times larger than the original and therefore takes that much longer to send and may therefore be more prone to corruption.

By sending the original Adobe Acrobat PDF file to the data delivery device 122 and letting it do the print formatting, the laboratory no longer needs to know what type of printer is maintained by each client, no longer needs to convert it to the much larger print image and no longer needs to take all that extra time or expense to send it. Further, with a copy of the original report now at the client site, it can be converted into several new formats for printing, viewing via a web browser, for sharing over a local network, or other functions appreciable by one of ordinary skill in the art. Once the transmitted data file has been manipulated and/or extracted for populating a report template by the report processing program 135 and thus create a report, the report can then be sent to the web server 124 or I/O interfaces 128 either automatically or upon receiving a command to do so from the web server 124 and/or I/O interfaces 128.

The I/O interfaces 128 can support a wide variety of connectivity means, each individually appreciable by one of ordinary skill in the art such as serial ports, parallel ports, phone jacks, Ethernet jacks, 802.11x wireless networking card slots, USB ports, Bluetooth antenna, etc. Such a wide variety of connectivity supported by the data delivery device 122 allows for connectivity options to a wide variety of equipment, and including other communication devices located in or remote to the physician's office 104. Files can be transferred by FTP, HTTP, HTTPS, Telnet, SSL and other networking protocols appreciable by one of ordinary skill in the art. Each provides additional security, error free transmission, and far greater speed than teletype transmission. Reports or data files generated by the host computer 102 or the data delivery device 122, itself, can now be transferred to a remote device simply, quickly, and the accuracy of the transmitted reports is immediately verifiable or automatically verified.

As shown in FIG. 1, the devices that can be in communication with data delivery device 122 include printers 138, computers 140, mobile devices 142 such as cell phones, blackberries, Personal Digital Assistants (PDA's), etc., databases 144 remote to the data delivery device 122 connectivity to an existing LAN 146, security devices 148 such as USB security keys, as well as other equipment and communication devices appreciable by one of ordinary skill in the art. Further, the data delivery device 122, through utilization of its own dedicated web server 124 and public Internet network connection capability, may be accessible by a user remote or local to the doctor's office through a web browser, possibly through a secure means such as HTTPS protocol requiring user name and password to access. The user can control and troubleshoot devices the I/O interfaces 128 of the data delivery device 122 are attached to.

Networking also allows the remote data delivery device 122 to interact with the end user in new and different ways. For example, a physician can now access the data delivery device 122 to access received lab reports using his web browser and print them on his own printer. The data delivery device 122 can also be configured to print received reports on an existing network printer in some other part of the building/world through a network 106. It is even possible to specify that some reports should print on one printer and others should print on another. Such activity may be logged in the memory 130 and also accessible through a web browser for confirmation and troubleshooting capabilities. Further, should the printer produce an error or fail to print, messages (such as toner low, paper jam, etc.) can be relayed from the printer to a remote user accessing the web server 124 via a web browser. Moreover, diagnostic checks or even commands from a web browser to the printer may be sent to the printer via the I/O interfaces 128 of the data delivery device 122. Additionally reports may be converted to various formats and sent to a doctor's PDA, cell phone or other mobile communication device 142, or to a computer or computer network remote from the office or hospital, to a doctor's dedicated webpage, email address or electronic delivery means. The data delivery system 122 may also use its connectivity capabilities to send reports and medical data to patient management systems.

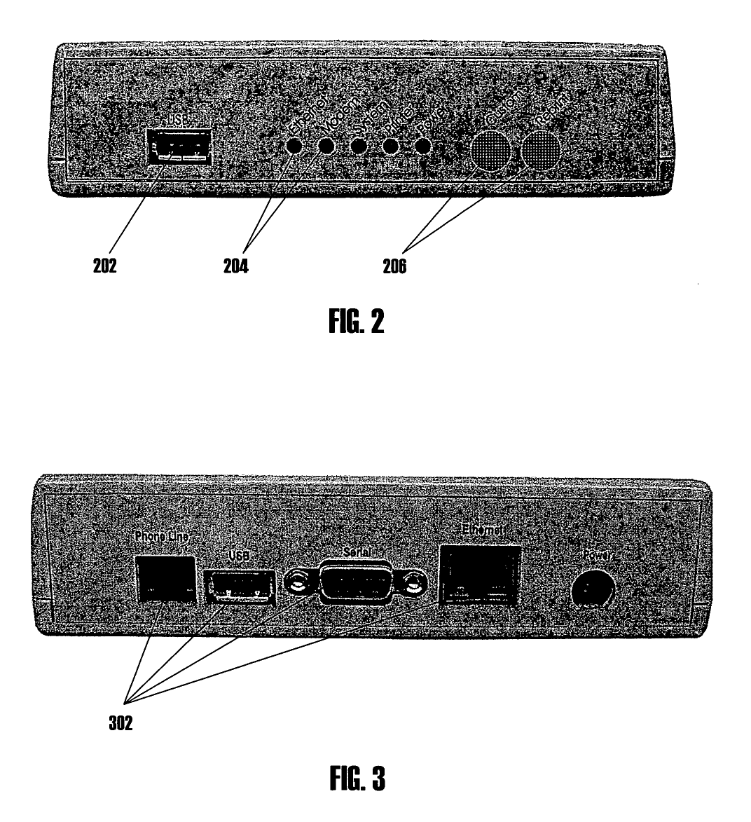

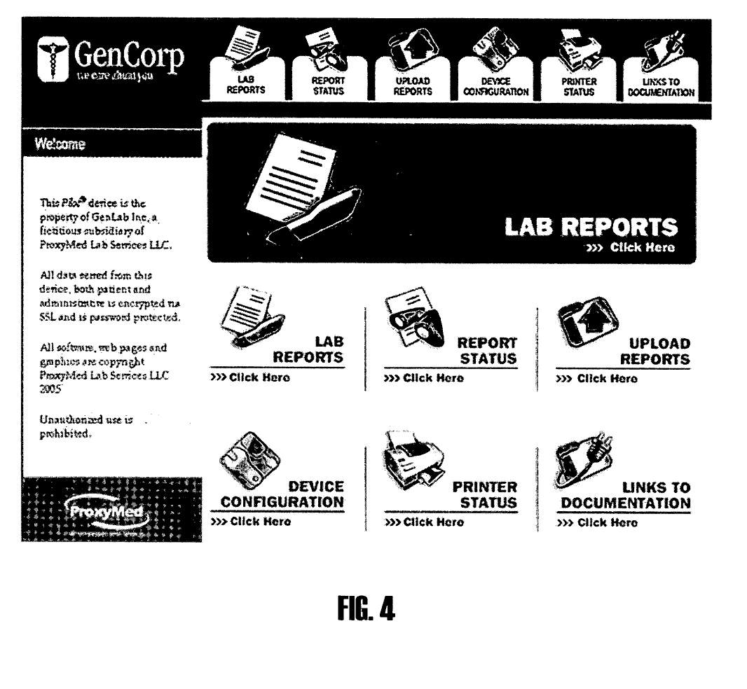

FIGS. 2 and 3 are frontal and rear views of a data delivery device 122, respectively, in accordance with an exemplary embodiment of the present invention. As shown in FIG. 2, a USB interface 202 is part of the I/O interface 128 on the data delivery device 122, and allows the data delivery device 122 to connect to any device or added feature such as portable memory sticks (or other external memory devices), hand held computer synchronization, and data transfer. USB interfaces also can provide support for printers, Bluetooth interfaces, WiFi interfaces, encrypted security keys, software updates from a memory key, as well as other devices capable of communicating through a USB interface. The front view of the data delivery device shows an LED display 204 with indicator lights to allow a user to know what particular operation the data delivery device 122 is undertaking and to allow additional troubleshooting of the device itself or a device in communication with the data delivery device 122. Also on the front of the device are buttons 206. These buttons 206 provide another user means for communicating with the data delivery device 122 and inputting commands to the device to perform operations including reprinting a report, forwarding a report on to a particular location, halting a transmission, resetting the device to a particular pre-set state. As one of ordinary skill in the art will appreciate, this on-box user interface may be expanded to include one or more LCD displays, and/or displays incorporating touch screen technology to provide further user interaction at the physical device itself to provide all or some of the functionality a user has through a web browser, as discussed with reference to FIG. 1 above.

As shown in FIG. 3, various connectivity options 302 are supported by the device such as serial ports, phone jacks, Ethernet jacks, USB ports as well as other connectivity options not shown in FIG. 3. These connection points allow for the functioning of the I/O interface 128 discussed with reference to FIG. 1.

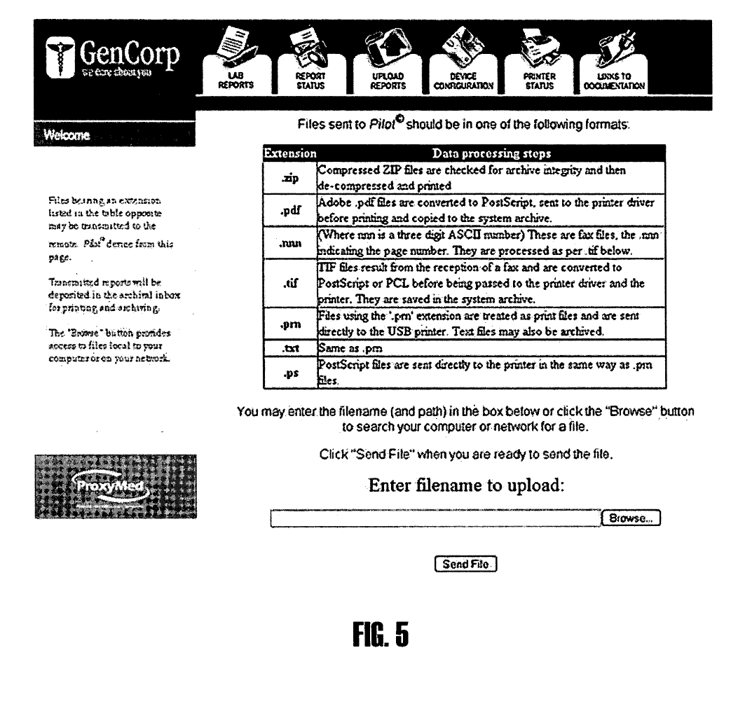

FIG. 4 is an example of the web interface allowing remote access to the data delivery device 122 in accordance with an exemplary embodiment of the present invention. In an exemplary embodiment of the present invention, this webpage would only be accessible after the submission of a user name and password over a secured network protocol such as HTTPS or other forms of encryption techniques appreciable by one of ordinary skill in the art. The user can select what interaction the user wants with the data delivery device by selecting an icon corresponding to that type of device interaction. In FIG. 4, the types of interaction icons shown include Report Status, Upload Reports, Device Configuration, Printer Status, and Links to Documentation. However, other functionality discussed above with reference to FIG. 1 can also be supported on this web interface.

Selecting the Report Status icon allows a user to view the status and access reports or data files that the data delivery device 122 has received and stored in its memory 130. This page can be set to refresh automatically after a certain time period to make verification that a report or data file has been successfully delivered an easier process. By access the report, which may require an additional level password protection, a user can make adjustments to the look and feel of the application as well as the data reported itself (correct typos, incorrect information, etc.).

Selecting the Upload Reports icon allows a user to upload a report or data file to the data delivery device 122. Whereas selecting the Device Configuration icon allows a user to access the customizable parameters which establish how the device operates as discussed above with reference to FIG. 1. This icon may require additional password or other security clearance information to access a variety of parameter that may or may not be restricted depending on the identity the user. Selecting the Printer Status icon allows a user to view or troubleshoot the printer device that is connected to the delivery device. This allows the user to see if a report has printed, failed to print, what caused the failure, if the print is on-line, etc. It also can allow the printer to communicate with the printer through command prompts. Selecting the Links to Documentation icon allows a user to access documentation relating to the finctionality and operation of the data delivery device 122 as well as links to help desk and corporate web sites.

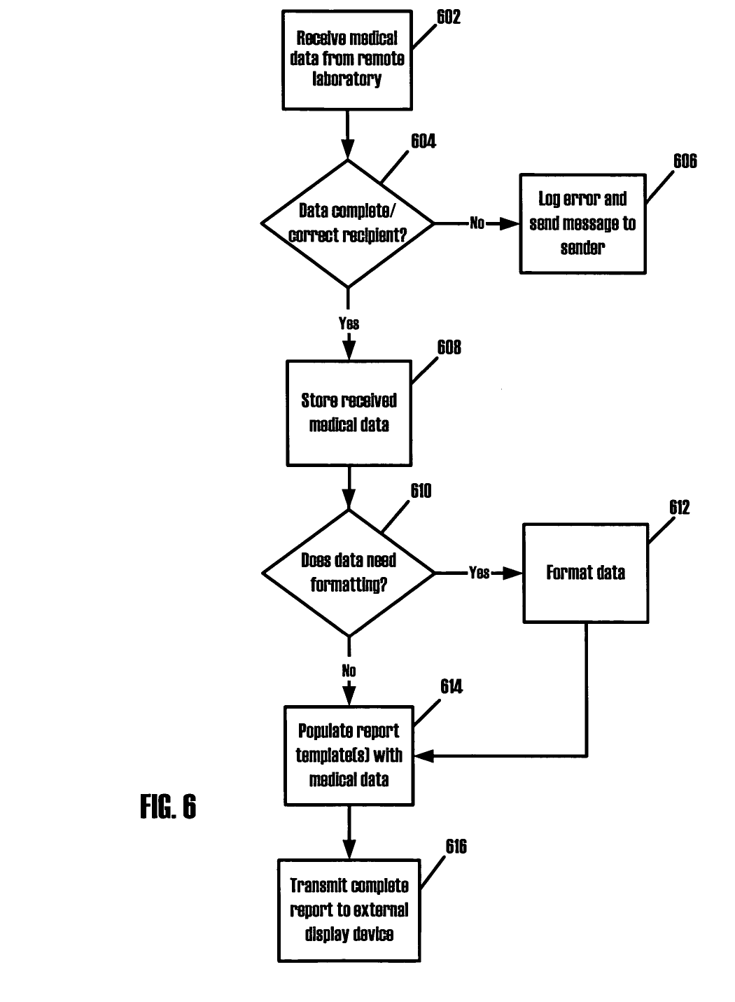

FIG. 5 is an example of a user interface, such as through a web browser, for uploading medical data and/or reports to the data delivery device 122 in accordance with an exemplary embodiment of the present invention. FIG. 5 demonstrates what the user would see had they selected the Upload Reports icon shown in FIG. 4. As shown in FIG. 5, a user is prompted to enter the file name of the report or data file the user wants to upload to the data delivery device 122 or browse the host computer 102 for which file(s) the user wants to send. In an exemplary embodiment, the user is notified what report and/or data file formats are supported by the particular data delivery device that will receive the report or data file (.zip, .pdf, .nnn, tif, .prn, .txt, .ps, etc). According to the exemplary embodiment of the invention shown in FIG. 5, compressed ZIP files may be checked for archive integrity and the de-compressed and printed; and Adobe PDF files may be converted to PostScript, sent to the printer driver before printing and copied to the system archive. Further, .nnn files may be fax files processed as .tif files, where .nnn is a three digit ASCII number representing the page number. TIF files may result from the reception of a fax and may be converted to PostScript or PCL before being passed to the printer driver and the printer. They may be saved in the system archive. Files using the .prn extension may be treated as print files and may be sent directly to the USB printer. Text files may also be archived. Further, .txt files may be treated the same as .prn files. PostScript files (.ps) may be sent directly to the printer in the same was as .prn files.

Additionally, each format has a description, which informs the user as to how the data delivery device will interpret and treat the file depending on the format extension used to deliver the report and/or data file. For example, in the exemplary embodiment of FIG. 5, files sent in Adobe Acrobat PDF format are send directly to the printer drive to be ready for immediate printing should that be desired and a copy of the file is stored in the system archives (i.e., memory 130 of the data delivery device 122).

FIG. 6 is a flowchart of an exemplary process of medical data transfer using the data delivery device in accordance with an exemplary embodiment of the present invention. As shown in the exemplary embodiment of FIG. 6, the process of medical data transfer using the data delivery device begins at step 602 where medical data associated with one or more patients is sent from an outside source (e.g., laboratory host computer, clinic, hospital or other medical site) and is received over a network at a data delivery device. Next, step 604 is invoked to determine if the received medical data is complete and sent to the correct recipient (e.g., the data is identified as being associated with a patient of a particular doctor's office). If the data is not completely delivered or if the intended recipient is incorrect (or some other transmission error is detected in step 604), then step 606 may be invoked and an error message may be generated and transmitted to the sender along with a request for the correct data to be resubmitted if necessary. In alternative embodiments of the invention, the error may also be logged for system monitoring and/or auditing purposes. If the data is determined to be complete and sent to the correct recipient, then step 608 is invoked to store the received medical data in an associated database.

According to an exemplary embodiment of the invention the data delivery device provides one or more report templates. Step 610 determines if additional formatting must be conducted to at least a portion of the received medical data to be compatible with at least one report template. If such formatting is necessary, then step 612 is invoked to perform the necessary data manipulation/transformation to be made useable and/or recognizable for generating a customized report using the report templates. Once the received medical data is properly formatted (or if step 612 was unnecessary because the received medical data needed no further transformation to be utilized with the report templates to generate a complete report), then step 614 is invoked where at least a portion of the received medical data is used to populate at least one report template with at least a portion of the plurality of medical data. Once the report templates have been populated with the appropriate received medical data the completed report is ready for display to the doctor, staff, and/or patient. In step 616 a user may initiate, through a user interface, the transmission of at least one populated report template to at least one external device to display the populated report template. In alternative embodiments of the invention, the transmission of a complete report to a particular external device may occur automatically without intervention from a user. In the exemplary embodiment of FIG. 6, the external device is an external display device such as a monitor, personal computer (PC), printer, or mobile device such as a cell phone, PDA, blackberry, etc.

In exemplary embodiments of the invention, he user interface may be accessible via a web browser and/or require a password log-in. Alternatively, a user interface may be integrated into the data delivery device. In exemplary embodiments of the invention, the use of a user interface may also allow for addition device and report customization to tailor the data delivery device to the particular preferences and/or needs of a particular doctor's office. This customization of reports and device operations may through the use of parameters, discussed above with reference to FIG. 1. For example, in response to receiving a request from the user interface, one or more parameters may be adjusted to change one or more appearance attributes (colors, graphics, logos, charts, figures, accompanying text, data fields, etc.) of a report template or the configuration of a particular interface on the device, etc.

Accordingly, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for delivering electronic medical data, comprising:
receiving medical data associated with a patient over a network;
providing a plurality of report templates;
populating at least one report template with at least a portion of the medical data;
providing a user interface for receiving user instructions relating to the utilization of at least a portion of the medical data; and
in response to receiving a request from the user interface, transmitting at least one populated report template to at least one external display device.

2. The method of claim 1, further comprising, formatting at least a portion of the received medical data to be compatible with at least one report template.

3. The method of claim 1, further comprising, providing a plurality of parameters for customizing report templates, wherein the parameters are accessible by the user interface; and
in response to receiving a user input to the user interface, adjusting at least one parameter to alter at least a portion of at least one report template.

4. The method of claim 1, wherein the user interface is accessible via a web browser.

5. The method of claim 1, wherein the user interface requires a password log-in.

6. The method of claim 1, further comprising determining if the received medical data is complete and sent to the correct recipient.

7. The method of claim 6, further comprising storing the received medical data.

8. A medical data delivery device, comprising:
a web server in communication with a network for receiving medical data;
at least one memory location containing medical report templates;
a plurality of interfaces, wherein at least one of the interfaces is in communication with at least one external device; and
a processor in communication with the web server for receiving the medical data and executing computer-executable instructions for:
retrieving at least one medical report template from the at least one memory location,
populating the retrieved at least one medical report template with at least a portion of the received medical data, and
transmitting the populated at least one medical report template to at least one interface for transmission to at least one external device.

9. The device of claim 8, further comprising a database containing a plurality of parameters for customizing report templates; and
wherein the computer-executable instructions executed by the processor further include instructions for adjusting at least one parameter to alter at least a portion of at least one report template.

10. The device of claim 8, wherein the computer-executable instructions executed by the processor further include instructions for formatting at least a portion of the received medical data to be compatible with at least one report template.

11. The device of claim 10, further comprising, a database containing a plurality of parameters for customizing a plurality of data formats compatible with at least one report template; and
wherein the computer-executable instructions executed by the processor further include instructions for adjusting at least one parameter to alter the plurality of data formats compatible with at least one report template.

12. The device of claim 8, wherein the plurality of interfaces includes a user interface accessible from a remote computing device for accepting commands to be executed by the processor.

13. The device of claim 8, wherein the plurality of interfaces includes at least four different interface types being selected from the group of interfaces types consisting of serial ports, parallel ports, phone jacks, Ethernet jacks, 802.11x wireless networking card slots, USB ports, and Bluetooth antennae.

14. The device of claim 8, wherein the computer-executable instructions executed by the processor further include instructions for determining if the received medical data is complete and sent to the correct recipient.

15. The device of claim 8, further comprising a database, wherein the computer-executable instructions executed by the processor further include instructions for storing at least a portion of the received plurality of medical data in the database.

16. A system for delivering medical data to a remote location, comprising:
a host computer, wherein the host computer contains medical data associated with a patient;
a data delivery device in communication with the host server through a network, wherein the data delivery device includes:
at least one memory location containing a plurality of medical report templates,
a plurality of interfaces, wherein at least one of the interfaces is in communication with at least one external device, and
a processor in communication with at least one interface for receiving the medical data and thereafter executing computer-executable instructions for:
retrieving at least one medical report template from the at least one memory location,
populating the retrieved at least one medical report template with at least a portion of the received medical data, and
sending the populated at least one medical report template to at least one interface.

17. The system of claim 16, wherein the data delivery device further includes a web server for remote system monitoring and auditing over the network.

18. The system of claim 16, wherein the data delivery device is remotely located from the host computer.

19. The system of claim 16, wherein the external device may be selected from a printer, personal computer (PC), and a mobile device.

20. The system of claim 16, wherein the external device is in communication with the data delivery device through a second network.
